(19) United States
(12) Patent Application Publication
(10) Pub. No.: US 2016/0335601 A1
(43) Pub. Date: Nov. 17, 2016

(54) SYSTEM AND METHOD FOR TRANSPARENT RECRUITMENT

(71) Applicant: MANIKANTH DORNADULA, BENGALURU (IN)

(72) Inventor: MANIKANTH DORNADULA, BENGALURU (IN)

(21) Appl. No.: 14/748,273

(22) Filed: Jun. 24, 2015

(30) Foreign Application Priority Data
May 12, 2015 (IN) 2421/CHE/2015
Jun. 24, 2015 (IB) PCT/IB2015/054733

(51) Int. Cl. G06Q 10/10

(52) U.S. Cl. CPC G06Q 10/1053

(57) ABSTRACT

The present invention provides a system and method for hiring a candidate who are available for certain joining period and also provide partial incentive to the candidates after accepting the offer, in which the candidates can update their profile including their joining period and the employer can view, sort, search, display the candidates profile based on the candidates profile parameters. Further, the system is configured to track, record and display of all the activities performed in recruitment process to facilitate the recruitment team, thus can facilitate the employers to know the various stages of the candidate's recruitment at other employer places till placement. In further, the system is configured to provide partial incentive at the time of joining in an organization/employer and remaining incentive after completion of certain duration of employment.

### FIELD OF INVENTION

The embodiments herein generally relate to recruitment system. More specifically, the embodiments described herein relate to a platform to provide transparent recruitment process and system. Particularly, relates to a system and method for transparent recruitment which can facilitate the employers to know the various stages of the candidate's recruitment at other places, and also incentivize the candidates for their recruitment.

### BACKGROUND OF THE INVENTION

Recruitment refers to the overall process of attracting, selecting and appointing suitable candidates for jobs within an organization, either permanent or temporary, unpaid positions, such as voluntary roles or training programmes. Internet-based technologies to support all aspects of recruitment have become widespread.

Sourcing is the use of one or more strategies to attract or identify candidates to fill job vacancies. It may involve internal and/or external recruitment advertising, using appropriate media, such as local or national newspapers, specialist recruitment media, professional publications, window advertisements, job centers, or in a variety of ways via the internet. Alternatively, employers may use recruitment consultancies or agencies to find otherwise scarce candidates who may be content in their current positions and are not actively looking to move companies.

An external recruiter may suit small organizations without the facilities to recruit. Typically, a formal contract for services is negotiated, known in the industry as Recruitment Process Outsourcing. It may involve strategic consulting for talent acquisition, sourcing for select departments or skills, or total outsourcing of the recruiting function.

Employment agencies operate in both the public and private sectors. The commercial recruitment industry is based on the goal of providing a candidate to a client for a price. At one end of the spectrum, there are agencies that are paid only if they deliver a candidate that successfully stays with the client beyond the agreed probationary period. On the other end, there are agencies that are paid a retainer to focus on a client's needs and achieve milestones in the search for the right candidate, and then again are paid a percentage of the candidate's salary when a candidate is placed and stays with the organization beyond the probationary period.

Recruitment websites have two main features: job boards, usually with a job search engine, a meta-search engine, which searches across multiple websites, and a résumé or curriculum vitae (CV) database. Job boards allow member companies to post job vacancies. Alternatively, candidates can upload a résumé to be included in searches by member companies. Fees may be charged for job postings and access to search resumes.

The online software provided by those who specialize in online recruitment helps organizations attract, test, recruit, employ and retain quality staff with a minimal amount of administration. Online recruitment websites can be very helpful to find candidates that are very actively looking for work and post their resumes online.

However, it has been observed that the conventional recruitment websites and/or online software do not provide transparency for the recruiter/employer about the candidates' interest in various companies, and their progress on various stages of recruitment process. Further, it has been observed that the candidates are not encouraged and/or monetized for their skill and appointment with an employer through the online system.

Therefore, there is a need in prior art to develop a system and method for transparent recruitment process to not only overcome the problem associated with the prior art but also to provide transparency in recruitment process and also incentivize the candidates for their recruitment.

### OBJECTS OF THE INVENTION

Some of the objects of the present disclosure are described herein below:

A main object of the present invention is to provide a system and method for transparent recruitment.

Another object of the present invention is to provide a system and method for track, record and display of all the activities performed in recruitment process to facilitate the recruitment team.

Yet another object of the present invention is to provide a system and method for transparent recruitment which can facilitate the employers to know the various stages of the candidate's recruitment at other employer places till placement.

Still another object of the present invention is to provide a system and method for providing incentive to the candidates for the confirmation and/or joining for an employment.

Another object of the present invention is to provide a system and method for providing partial incentive at the time of joining in an organization/employer and remaining incentive after completion of certain duration of employment.

Another object of the present invention is to provide a recruitment engine to offer high level of transparency to the resourcing team of the organizations in candidate selection process.

Another object of the present invention is to provide a system and method in which the candidates can update their profile including their joining period.

Another object of the present invention is to provide a system and method which can facilitate the organization to hire candidate of their required skill who are available to join within certain period.

The other objects and advantages of the present invention will be apparent from the following description when read in conjunction with the accompanying drawings which are incorporated for illustration of preferred embodiments of the present invention and are not intended to limit the scope thereof.

### SUMMARY OF THE INVENTION

In view of the foregoing, an embodiment herein provides a system and method for transparent recruitment, wherein the system and method can be utilized for hiring a candidate who are available for certain joining period and also provide partial incentive to the candidates after accepting the offer, in which the candidates can update their profile including their joining period and the employer can view, sort, search, display the candidates profile based on the candidates profile parameters. The system and method described herein can be utilized for the employer to view, sort and display the joining period of candidates based on their interest. Further, the method and system for transparent recruitment can be utilized for track, record and display of all the activities performed in recruitment process to facilitate the recruitment team, thus can facilitate the employers to know the various stages of the candidate's recruitment at other employer places till placement. Accordingly, the system and method can provide high level of transparency to the resourcing team of the organizations in candidate selection process. In addition, the method and system for transparent recruitment can be utilized for providing incentive to the candidates for the confirmation and/or joining for an employment. Moreover, the system and method can be utilized for providing partial incentive at the time of joining in an organization/employer and remaining incentive after completion of certain duration of employment.

According to an embodiment, the recruitment system may include a server, a controller, a database, a network, an interface device, and a recruitment engine, wherein the recruitment engine may include several components that may be configured to perform various operations. Accordingly, the recruitment engine can include a registration module, a login module, a candidates' profile module, a job post module, a matching module, a candidates' recruitment progress module, a placement acceptable module, an incentive module, an employment track module and other modules.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The detailed description is set forth with reference to the accompanying figures. In the figures the use of the same reference numbers in different figures indicates similar or identical items.

FIG. 1 illustrates a sample network environment for implementing system and method of transparent recruitment, according to an embodiment therein;

FIG. 2 illustrates a schematic diagram of recruitment engine of the transparent recruitment system, according to an embodiment therein;

FIG. 3 illustrates role of candidates in the transparent recruitment system and method, according to an embodiment therein; and

FIG. 4 illustrates role of employer in the transparent recruitment system and method, according to an embodiment therein.

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

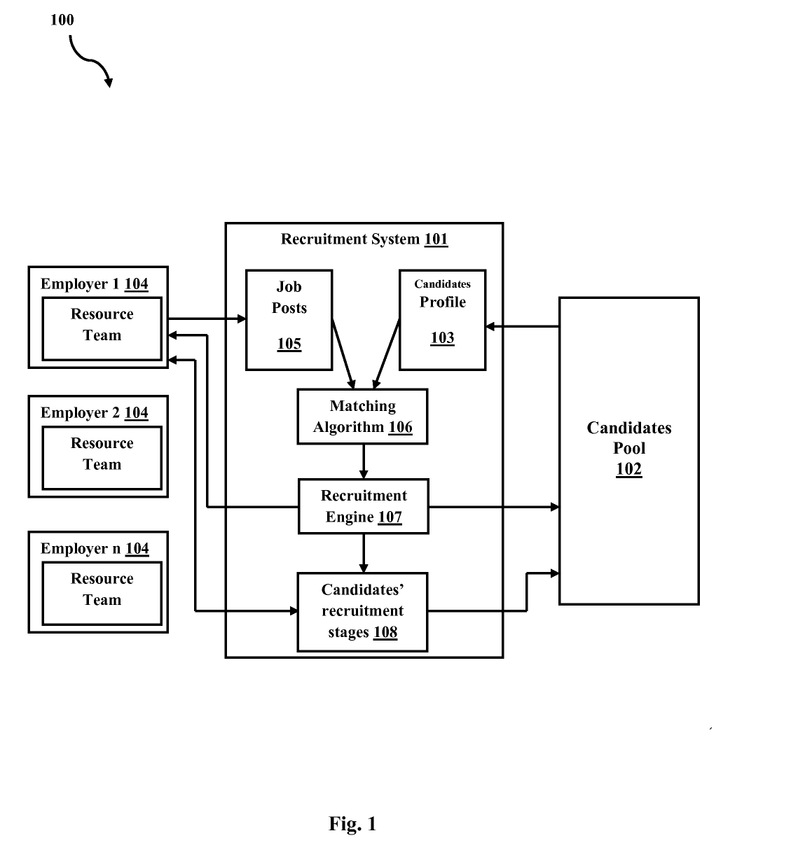

As mentioned above, there remains a need for a transparent recruitment process system. The embodiments herein achieve this by providing architecture for implementing a system and method of transparent recruitment. The recruitment system includes a recruitment engine to facilitate the employer to hire candidate of their required skill who are available to join within certain joining period and also provide partial incentive at the time of joining in an employer and remaining incentive after completion of certain duration of employment. Referring now to drawings, and more particularly to FIGS. 1 through 4, where similar reference characters denote corresponding features consistently throughout the figures, there are shown preferred embodiments. As used herein, the term “and/or,” when used in a list of two or more items, means that any one of the listed items can be employed by itself, or any combination of two or more of the listed items can be employed.

In some example embodiments, method and system for transparent recruitment process can be utilized for hiring a candidate who are available for certain joining period and also provide partial incentive to the candidates after accepting the offer, in which the candidates can update their profile including their joining period and the employer can view, sort, search, display the candidates profile based on the candidates profile parameters. The system and method described herein can be utilized for the employer to view, sort and display the joining period of candidates based on their interest.

In some example embodiments, method and system for transparent recruitment can be utilized for track, record and display of all the activities performed in recruitment process to facilitate the recruitment team, thus can facilitate the employers to know the various stages of the candidate's recruitment at other employer places till placement. Accordingly, the system and method can provide high level of transparency to the resourcing team of the organizations in candidate selection process. In case, the candidates are not selected in any one of the employer, the same information may not be displayed to all the employers.

In some example embodiments, method and system for transparent recruitment can be utilized for providing incentive to the candidates for the confirmation and/or joining for an employment. Moreover, the system and method can be utilized for providing partial incentive at the time of joining in an organization/employer and remaining incentive after completion of certain duration of employment.

FIG. 1 illustrates a sample network environment 100 for implementing system and methods of transparent recruitment, according to an embodiment of the present invention. As shown in FIG. 1, the network environment 100 may include a server, a controller, a database, a network, an interface device (not shown), wherein the server includes a recruitment system 101. The server can be configured to run one or more application and connected and communicated to the database. The recruitment system may include a matching algorithm 106 and recruitment engine 107. The network can comprise a plurality of data processing nodes interconnected for the purpose of data communication. Other components of the network environment can utilize the network to receive, transmit, and store data as well as for the purpose of accessing remote resources. The employer and candidates' pool can access the recruitment system using the interface device.

The database may be utilized to store data processed by the recruitment engine 107. In some example embodiments, the data stored in the database can originate in transactions external to the recruitment engine 107. The database can also store data/information related to candidates profile including joining period and job posting of the employer. The interface device (not shown) can be included in various interface devices including portals to facilitate transmitting and receiving data over the network. The interface device can permit the candidates and employers to interact with the recruitment system 101 and/or recruitment engine 107.

The representation of the interface device in the form of a computing system or handheld computing system, within which a set of instructions for causing the device to perform any one or more of the methods described herein may be executed. In various example embodiments, the device operates as a standalone device or may be connected (e.g., networked) to other devices. In a networked deployment, the device may operate in the capacity of a server or a client device in a server-client network environment, or as a peer device in a peer-to-peer (or distributed) network environment. The interface device can include but not limited to mobile telephone, tablet, laptop, personal digital assistant (PDA), smart phone, a web appliance, or any device capable of executing a set of instructions (sequential or otherwise) that specify actions to be taken by that device. Further, while only a single device is illustrated, the term “device” shall also be taken to include any collection of devices that individually or jointly execute a set (or multiple sets) of instructions to perform any one or more of the methods discussed herein.

The exemplary interface device can include a processor or multiple processors (e.g., a central processing unit (CPU), a graphics processing unit (GPU), or both), a main memory, and a static memory, which communicate with each other via a bus. The interface device may further include a display unit (e.g., a liquid crystal display (LCD)). The interface device may also include an alphanumeric input device (e.g., a keyboard), an image capturing device (e.g. camera), a cursor control device (e.g., a mouse), a signal generation device (e.g., a speaker, mic) and a network interface device.

The recruitment engine can be utilized to process of registration, candidate profile listing, job positing, matching profile, candidates' recruitment progress, placement acceptable, partial incentivizing for offer acceptable, and tracking of employment. The instructions or commands may further be transmitted or received over a network via the interface device utilizing any of the transfer protocols (e.g., Hyper Text Transfer Protocol (HTTP). The example embodiments described herein may be implemented in an operating environment comprising software installed on the interface device, in hardware, or in a combination of software and hardware.

In accordance with an embodiment, one or more employers 104 can register on the system 101 to post/list the job 105 availability in their organization along with the required joining period of candidates. The employer 104 may comprise resource team to handle, interact, view, sort, and display the candidates profile including the joining period of candidates using an interface device. The interface device enables the employer 104 to interact with the recruitment system 101 and/or recruitment engine 107.

In accordance with an embodiment, candidates' pool 102 can register on the system 101 to provide the candidates profile 103 including joining period, and can have option to display the profile in public or private. Based on the available candidates' profile 103 and available job 105, the matching algorithm 106 can segregate the desired candidate profile to the employer. Based on the matching profile, the recruitment engine 107 may send notification to the employer as well as the candidates. Thereafter, the candidates' goes through the various stages 108 of recruitment process such as written test, interview, group discussion, reference and checks, follow-up after interview, salary negotiation and signing of contract. In accordance with an embodiment, the recruitment engine 107 is configured to track, record and display of all the activities performed in recruitment process to facilitate the recruitment team.

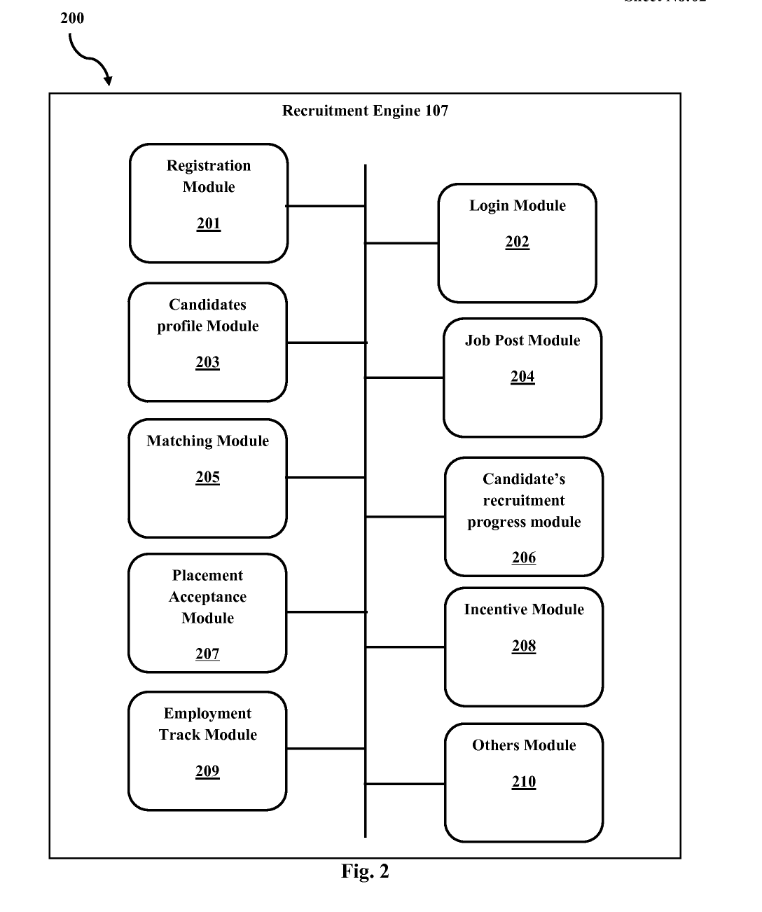

FIG. 2 illustrates a schematic diagram 200 of recruitment engine 107 of the transparent recruitment system, according to an embodiment. The recruitment engine may include a registration module 201, a login module 202, a candidates' profile module 203, a job post module 204, a matching module 205, a candidates' recruitment progress module 206, a placement acceptable module 207, an incentive module 208, an employment track module 209 and other modules 210.

In accordance with an embodiment, the registration module 201 can be configured to register the candidates along with their mandatory information which can include, for example, name, current employer, designation, location, remuneration, joining period and so on. Further, the registration module 201 can be configured to register employers along with their mandatory information which can include, for example, employer name, address, location and among others. All the mandatory information may not be made available to the public.

In accordance with an embodiment, the login module 202 can be configured to access the system 101 only with valid registered candidates and/or employers in order to view, sort, display and search the candidates profile and/or job posting.

In accordance with an embodiment, the candidates profile module 203 can be configured to allow the candidates to enter, store, and display with option for the candidates' profile including but not limited to name, current employer, salary, designation, joining period and so on, wherein the display option can be made public or private to the registered employers.

In accordance with an embodiment, the job posting module 204 can be configured to allow the employers to enter, store and display with option for job positing details which can include, for example employer name, job title, salary offer, number of position, location, required joining period timeline and so on, wherein the display option can be made public or private to the registered candidates.

In accordance with an embodiment, the matching module 205 can be configured to match the candidates profile along with job positing of employers and can segregate the candidates profile based on the nature of job posting and can be stored in the database in a segregated manner, so that the employer can easily view, sort the required candidates profile.

In accordance with an embodiment, the candidate's recruitment progress module 206 can be configured to track, record and display of all the activities performed in recruitment process and to facilitate the recruitment team, thus can facilitate the employers to know the various stages of the candidate's recruitment at other employer places till placement. Accordingly, the system can provide high level of transparency to the resourcing team of the organizations in candidate selection process.

In accordance with an embodiment, the placement acceptance module 207 can be configured to allow the employers to provide placement offer to the candidates, and based on the placement offer and his interest, the candidates can either accept or reject the placement offer.

In accordance with an embodiment, the incentive module 208 can be configured to provide, after acceptance of the placement offer, partial incentive at the time of joining with the employer and remaining incentive after completion of predetermined duration of employment with the employer.

In accordance with an embodiment, the employment track module 209 can be configured to monitor and record the actual duration of employment with the employers and also to compare with the actual duration of employment with the predetermined duration of employment in order to make eligible for the remaining incentives to the candidates.

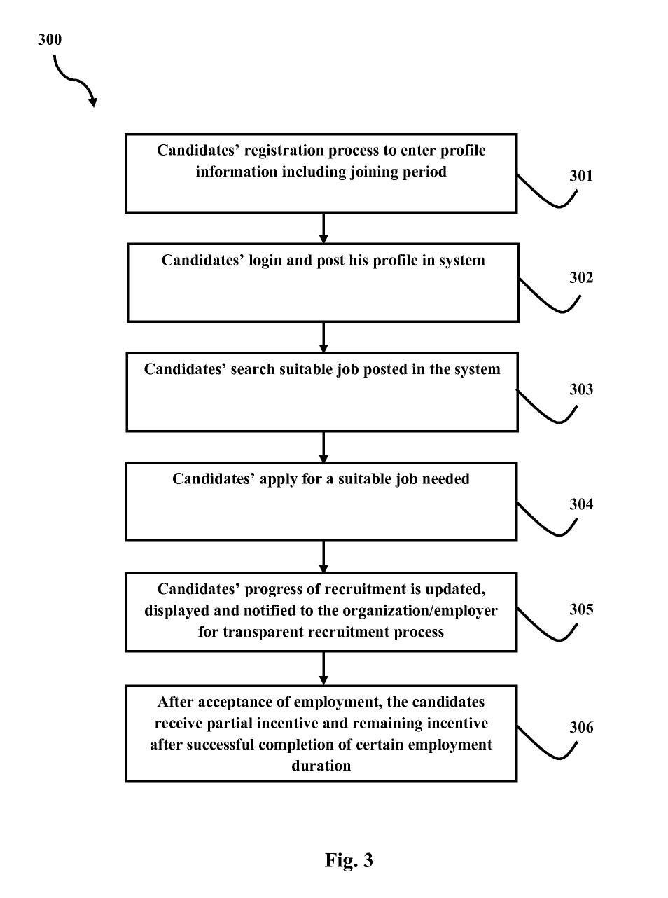

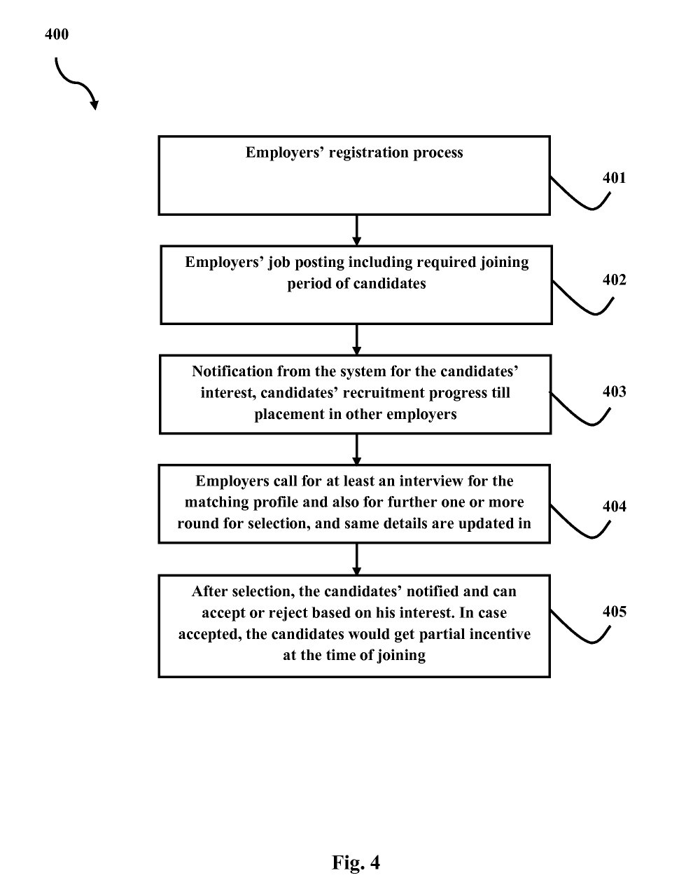

Exemplary methods for implementing system of providing transparent recruitment are described with reference to FIG. 3 to FIG. 4. The methods are illustrated as a collection of operations in a logical flow graph representing a sequence of operations that can be implemented in hardware, software, firmware, or a combination thereof. The order in which the methods are described is not intended to be construed as a limitation, and any number of the described method blocks can be combined in any order to implement the methods, or alternate methods. Additionally, individual operations may be deleted from the methods without departing from the spirit and scope of the subject matter described herein. In the context of software, the operations represent computer instructions that, when executed by one or more processors, perform the recited operations.

FIG. 3 illustrates role of candidates in the transparent recruitment system and method, according to an embodiment. At block 301, the candidates may register the name along with their mandatory information which can include, for example, userid, current employer, designation, location, remuneration, joining period and so on.

At block 302, the candidates may login in to the system to access the job positing details of the employers which can include, for example, employer name, job title, salary offer, number of position, location, required joining period timeline.

At block 303, the candidates may perform search based on the keywords to find a suitable job posting based on his interest.

At block 304, the candidates may apply for a suitable job posted/listed and the candidates may be selected based on the employers requirement.

At block 305, the system may track, record and display of all the activities performed in recruitment process, thus can facilitate the employers to know the various stages of the candidate's recruitment at other employer places till placement.

At block 306, after acceptable of employment, the candidates may receive incentive for the confirmation and/or joining for an employment. Further, the candidates can receive partial incentive at the time of joining in an organization/employer and remaining incentive after completion of certain duration of employment.

FIG. 4 illustrates role of employer in the transparent recruitment system and method, according to an embodiment. At block 401, the employers may register in the system along with their mandatory information which can include, for example, employer name, address, location and so on.

At block 402, the employers may post/list the available job as job positing which can include for example, employer name, job title, salary offer, number of position, location, required joining period timeline and so on.

At block 403, the employers may receive notification from the system for candidates' interest, candidates' recruitment progress till placement in other employers. In case, the candidates are not selected in any one of the employer, the same information may not be displayed to all the employers.

At block 404, the employers may call for an interview for the matching profile candidates and also can perform one or more round selection, and the same details are updated in the system.

At block 405, after selection of candidates, the candidates' may be notified about his selection of placement offer. Further, the candidates may accept or reject the offer based on his interest. In case accepted, the candidates may get partial incentive at the time of joining

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A system for transparent recruitment comprising
a server, a controller, a database, a network, and an interface device, wherein the server is connected and communicated with the database and includes a recruitment engine, wherein the recruitment engine include
a registration module configured to register the candidates along with their mandatory information and to register the employer along with their mandatory information;
a login module configured to access the system only with valid registered candidates and/or employers;
a candidates' profile module configured to allow the candidates to enter, store, and display for the candidates' profile;
a job post module configured to allow the employers to enter, store and display for job posting details, a matching module configured to match the candidates profile along with job posting of employers and can segregate the candidates profile based on the nature of job posting; and
a candidates' recruitment progress module configured to track, record, and display of all the activities performed in recruitment process to the employers thus facilitates the employers to know various stages of the candidate's recruitment at other employer places till placement.

2. The system as claimed in claim 1, wherein the recruitment engine further comprises of a placement acceptable module configured to allow the employers to provide placement offer to the candidates; and
an incentive module configured to provide, after acceptance of the placement offer, partial incentive at the time of joining with the employer and remaining incentive after completion of predetermined duration of employment with the employer.

3. The system as claimed in claim 1, wherein the recruitment engine further comprises an employment track module configured to monitor and record the actual duration of employment with the employers and also compare the actual duration of employment with the predetermined duration of employment in order to make eligible for the remaining incentive to the candidates.

4. The system as claimed in claim 1, wherein the candidate profile includes candidate name, current employer, salary, designation and joining period.

5. The system as claimed in claim 1, wherein the job posting details includes employer name, job title, salary offer, number of position, location, and desired joining period timeline.

6. A method for transparent recruitment, wherein the method comprising allowing to register the candidates with their mandatory information which includes userid, current employer, designation, location, remuneration and joining period;
allowing to register the employers with their mandatory information which includes employer name, address and location;
allowing the candidates to login into the system to access the job positing details of the employers;
allowing the candidates to apply for a suitable job posted and the candidates get selected based on the employers requirement; and
tracking, recording and displaying of all the activities performed in recruitment process to the employers thus facilitates the employers to know various stages of the candidate's recruitment at other employer places till placement.

7. The method as claimed in claim 6, wherein the method further comprising
allowing the employers to provide placement offer to the candidates;
receiving partial incentive by the candidates at the time of joining with the employer after acceptance of the placement offer; and
receiving remaining incentive by the candidates after completion of predetermined duration of employment with the employer.

8. The method as claimed in claim 6, wherein the method further comprising monitoring and recording the actual duration of employment with the employers and also comparing the actual duration of employment with the predetermined duration of employment in order to make eligible for the remaining incentive to the candidates.
